(19) United States
(12) Patent Application Publication
(10) Pub. No.: US 2008/0022816 A1
(43) Pub. Date: Jan. 31, 2008

(54) Anti-slip slot driver

(76) Inventor: William Michael Feldman, Farmington, CT (US)

Correspondence Address: William Feldman, 10F Talcott Ridge Rd, Farmington, CT, 06032, US

(21) Appl. No.: 11/881,098

(22) Filed: Jul. 25, 2007

Related U.S. Application Data
(60) Provisional application No. 60/833,167, filed on Jul. 25, 2006.

(51) Int. Cl. B25B 23/08

(52) U.S. Cl. 81/451

(57) ABSTRACT

One embodiment of the anti-slip slot screw driver having fins 18 which are perpendicular and on opposite sides of the slot driver 14 disallowing lateral slipping from the screw 22 and lateral alignment of the screw 22 in the work piece 10.

### CROSS-REFERENCE TO RELATED APPLICATIONS

This application claims the benefit of the provisional patent application APPL NO. U.S.60/833,167, filled 2006 Jul. 25 by the present inventor.

### FEDERALLY SPONSORED RESEARCH

Not Applicable

### SEQUENCE LISTING OF PROGRAM

Not Applicable

### BACKGROUND OF THE INVENTION

1. Field of the Invention

This invention relates to slotted fasteners and used for better security and control during fastening operations.

2. Prior Art

When handling slotted fasteners during their installation or removal a slip of the screwdriver out of one side of the slot is frequently observed. This typically causes extra time to re-insert driver into the slot, timely and frustrating screw re-alignment, or seldom inquiry due to slipping hand or loss of balance.

Several types of devises have been proposed to secure slot driver from slipping out of the slot of the screw which typically comprise of the sleeve type of enclosure around the screw head. Some of these sleeves are stationary such as in U.S. Pat. No. 3,884,282 to Dobrosielski (1975), some slide along the shank of the driver such as U.S. Pat. No. 797,078 to Shelton (1905), U.S. Pat. No. 3,517,714 to Desbarats (1970), U.S. Pat. No. 3,739,825 to Knox (1973), U.S. Pat. No. 4,736,658 to Jore (1988)

Although these concepts secure the fastener it adds cost to manufacturing of the slot screw driver. Cup design also blocks visibility of the slot locations on the screw head during fastening process.

Above-mentioned patents show a number of disadvantages:
(a) Complexity of the designs by having a numerous number of parts and machinability of the cup feature adds cost to the component.
(b) Cup design also blocks visibility of the slot location on the screw, which complicates screw driver engagement.

### SUMMARY

One anti slip slot screwdriver comprises of side fins located perpendicular and to two outer sides of the slot driver.

### DRAWINGS

### Figures

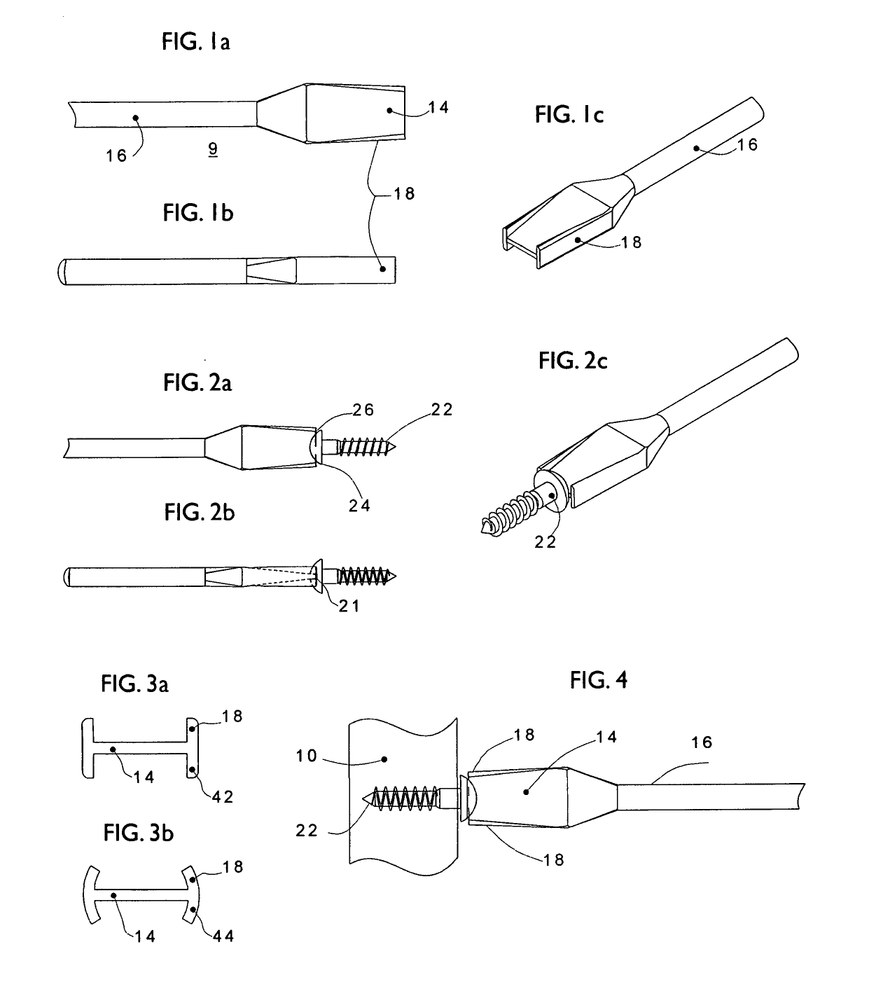

FIGS. 1a, 1b and 1c show various angles of slot anti-slip screw driver.

FIGS. 2a, 2b and 2c show various angles of slot anti-slip screw driver and driven crew.

FIGS. 3a and 3b show alternative cross sections of slot anti-slip screw driver.

FIG. 4 shows slot anti-slip screw driver with screw fitted into work piece.

### DRAWINGS

### Reference Numerals

9 anti-slip slot screw driver
10 work piece
14 slot driver
16 shank
17 fin
21 downward contact surface
22 screw
24 screw head
26 lateral contact surface
42 cross section 1
44 cross section 2

### DETAILS DESCRIPTION

### FIGS. 1a, 1b and 1c

### Preferred Embodiment

One embodiment of the screw driver is illustrated in FIG. 1a (top view), FIG. 1b (side view) and 1c (isometric view). The screwdriver has fins 18 located perpendicular to the slot driver 14 and set as a lateral stop for lateral contact surface 26 shown in FIG. 2a. Shank 16 is a typical neck of the slot driver 14 found in slot screw drivers available as a common equipment sold. Screw 22 with the screw head 24 are shown in FIGS. 2a, 2b and 2c in order to illustrate anti-slip slot screw driver 9 being engaged with screw 22 with lateral contact surface 26 and downward contact surface 21. FIGS. 3a and 3b show cross sections of anti-slip slot screw driver 9 lower section with slot driver 14 and fins 18. FIG. 4 shows final stage of anti-slip slot screw driver 9 and screw 22 being fastened into work piece 10.

### Operation—FIG. 4

For fastening slotted screw 22 into or out of work piece 10 using anti-slip slot screw driver 9 insert slot driver 14 into screw slot insuring screw head 24 is located between fins 18 and rotate clockwise or counter clockwise depending on desired insertion or removal of screw 22 in or out of the work piece 10. Additional use is possible by lateral adjustment of the screw in work piece 10 by applying lateral pressure of the fin 18 onto screw head 24 through lateral contact surface 26.

### Alternative Embodiment

### FIGS. 4a and 4b

Various possibilities exist for cross sections, which are shown but not limited to above illustrations. Alternative forms of fins 18 are acceptable provided that they satisfy the condition of the screwdriver 9 to be secure in the sot of the screw 22.

### ADVANTAGES

From the description above, there are number of advantages for use of anti-slip slot driver:
a) With the use of anti-slip screw driver slipping out of the slot during fastening process is eliminated.
b) Simplicity of the design is a cost effective solution to prior art referenced above.
c) Due to elimination of screwdriver re-insertion and screw re-positioning time savings will occur.
d) With use safety will increase as it will eliminate free slipping of the hand from the slot of the screw.
e) Use of the improved driver will help to adjust screw by applying lateral force of fins to the screw.

### CONCLUSION, RAMIFICATIONS AND SCOPE

Accordingly, the reader will see that the anti-slip slot driver of various embodiments can be used to engage slotted fastener in safe, frustration free manner with safety added to the process also presenting more control over the task.

Although the description above contains many specificities, these should not be constructed as limiting to the scope of the embodiment but as merely providing illustrations of some of the presently preferred embodiments. For example this slot driver can be part of hand-operated screwdrivers as well as motor driven and any other equipment, which will benefit from improved driver. In addition the fins can be straight, curved, circular etc. provided that they satisfy the functions described above.

I claim:

1. In a slot screw driver fins enabling lateral security.

2. The fins I claim to be perpendicular and on opposite sides of the slot driver.

3. The fins I claim allowing lateral screw adjustments.
